(19) United States
(12) Patent Application Publication
(10) Pub. No.: US 2007/0013308 A1
(43) Pub. Date: Jan. 18, 2007

(54) Black top green sheet, plasma display panel, and method for manufacturing the same

(76) Inventors: Dae Hyun Park, Yongin-si (KR); Kyung Ku Kim, Anyang-si (KR); Byung Hwa Seo, Seoul (KR); Min Soo Park, Seoul (KR); Won Seok Jeon, Suwon-si (KR); Dong Oh Shin, Gwacheon-si (KR); Deok Hai Park, Joong-gu (KR); Hong Cheol Lee, Masan-si (KR); Je Seok Kim, Anyang-si (KR); Byung Gil Ryu, Seoul (KR)

Correspondence Address: FLESHNER & KIM, LLP, P.O. BOX 221200, CHANTILLY, VA, 20153, US

(21) Appl. No.: 11/482,192

(22) Filed: Jul. 7, 2006

(30) Foreign Application Priority Data
Jul. 8, 2005 (KR) 10-2005-0061741
Sep. 6, 2005 (KR) 10-2005-0082618
Nov. 7, 2005 (KR) 10-2005-0106134

(51) Int. Cl. H01J 17/49

(52) U.S. Cl. 313/582

(57) ABSTRACT

A black top green sheet, a plasma display panel, and a method for manufacturing the same, in which black tops made of a photosensitive substance are formed, to improve the contrast of the plasma display panel, reduce the production costs of the plasma display panel, and simplify a process for manufacturing the plasma display panel. The method includes forming a barrier rib material on a lower plate, on which address electrodes and a dielectric are provided; forming a black top material comprising a photosensitive substance on the barrier rib material; patterning the black top material to form black tops; and patterning the barrier rib material using the black tops as a mask to form barrier ribs.

This application claims the benefit of Korean Patent Application No. 10-2005-0061741, filed on Jul. 08, 2005, Korean Patent Application No. 10-2005-0082618, filed on Sep. 06, 2005, Korean Patent Application No. 10-2005-0106134, filed on Nov. 07, 2005, which is hereby incorporated by reference as if fully set forth herein.

### BACKGROUND OF THE INVENTION

1. Field of the Invention

The present invention relates to a plasma display panel, and more particularly, to a plasma display panel, in which a process for forming black tops on a lower plate is simplified, and a method for manufacturing the same.

2. Discussion of the Related Art

Generally, in a plasma display panel, discharge cells are divided from each other by barrier ribs formed between a front substrate and a rear substrate. Each of the discharge cells is filled with a main discharge gas, such as neon gas, helium gas, or neon-helium mixed gas, and an inactive gas containing a small amount of xenon. When an electric discharge occurs by means of a high-frequency voltage, the inactive gas generates vacuum ultraviolet rays, and the vacuum ultraviolet rays cause fluorescent materials between the barrier ribs to emit light, thereby forming an image. The above-described plasma display panel has a small thickness and a light weight, thus being spotlighted as the next generation display device.

FIG. 1 is a schematic perspective view of a conventional plasma display panel. As shown in FIG. 1, a plurality of pairs of retaining electrodes, each of which includes a scan electrode 102 and a sustain electrode 103, are arranged on a front glass 101, serving as a display plane, on which an image is displayed, of a front substrate 100 of the plasma display panel. A plurality of address electrodes 113 are arranged on a rear glass 111 of a rear substrate 110 in such a manner that the address electrodes 113 intersect the pairs of the retaining electrodes. The rear substrate 110 is connected to the front substrate 100 in parallel under the condition that the rear substrate 110 and the front substrate 100 are spaced from each other by a designated distance.

Barrier ribs 112 formed in a stripe type (or a well type) for forming a plurality of discharge spaces, i.e., discharge cells, are arranged in parallel on the rear substrate 110. Further, a plurality of the address electrodes 113 for performing address discharge to generate vacuum ultraviolet rays are arranged in parallel with the barrier ribs 112. R, G, B fluorescent materials 114 for emitting visible rays to display an image when the address discharge occurs are applied to the upper surface of the rear substrate 110. A lower dielectric layer 115 for protecting the address electrodes 113 is formed between the address electrodes 113 and R, G, B fluorescent materials 114.

The above conventional plasma display panel is manufactured through a glass-manufacturing process, a front substrate-manufacturing process, a rear substrate-manufacturing process, and an assembling process.

First, the front substrate-manufacturing process includes forming scan electrodes and sustain electrodes on a front glass, forming an upper dielectric layer for limiting discharge current of the scan and sustain electrodes and insulating pairs of the scan and sustain electrodes from each other, and forming a protection layer on the upper dielectric by depositing magnesium oxide for facilitating the discharge condition

The rear substrate-manufacturing process includes forming address electrodes on a rear glass, forming a lower dielectric layer for protecting the address electrodes, forming barrier ribs on the upper surface of the lower dielectric layer for dividing discharge cells from each other, and forming a fluorescent material layer on regions between the barrier ribs for emitting visible rays.

The above method for manufacturing the plasma display panel has problems, as follows.

The barrier ribs serve to prevent electrical and optical crosstalk between the discharge cells, and are important to increase the display quality and the light-emitting efficiency of the plasma display panel. As the PDPs are developed towards large-size and high-definition trends, various researches on the barrier ribs have now been made.

First, a barrier rib material is formed on the lower dielectric layer by printing a barrier rib paste or laminating a barrier rib green sheet on the lower dielectric layer, and the barrier ribs are obtained by a sanding, etching, or photosensitive method. Here, in order to increase the contrast of the PDP, the formation of a black top on the upper surfaces of the barrier ribs is added to this barrier rib-forming process. That is, a black top material and a dry film resist (DFR) layer are sequentially formed on the barrier rib material on the lower dielectric layer. Then, after the barrier ribs and black tops are formed by a sanding method, the DFR layer is removed.

Since the barrier rib material, the black top material, and the DFR layer are sequentially formed on the lower dielectric layer, the above conventional barrier rib-forming process additionally requires separate materials and steps. Further, since the width of the pattern of the black tops cannot be adjusted, the luminance of the plasma display panel is deteriorated. Moreover, the side surfaces of the black tops are exposed to an etchant during the exposing and developing processes.

### SUMMARY OF THE INVENTION

Accordingly, the present invention is directed to a black top green sheet, a plasma display panel, and a method for manufacturing the same.

One object of the present invention is to provide a plasma display panel, in which a process for forming barrier ribs and black tops is simplified, and a method for manufacturing the same.

To achieve this object and other advantages and in accordance with the purpose of the invention, as embodied and broadly described herein, a method for manufacturing a plasma display panel includes forming a barrier rib material on a lower plate, on which address electrodes and a dielectric are provided; forming a black top material comprising a photosensitive substance on the barrier rib material; patterning the black top material to form black tops; and patterning the barrier rib material using the black tops as a mask to form barrier ribs.

In a further aspect of the present invention, a plasma display panel includes upper and lower plates, which face each other; barrier ribs formed on the lower plate and comprising a white material; and black tops formed on the barrier ribs and having a narrower width than that of the barrier ribs.

In another aspect of the present invention, a black top green sheet includes a photosensitive black paste layer, which has viscosity when it is not exposed to light, and loses the viscosity when it is exposed to the light; and first and second protection films provided on the upper and lower surfaces of the black paste layer.

In another aspect of the present invention, a method for manufacturing a plasma display panel includes preparing a black top green sheet, the viscosity of which is changed when it is exposed to light; selectively exposing the black top green sheet to light according to regions corresponding to barrier ribs; and bonding non-exposed portions of the black top green sheet to the barrier ribs provided on a lower plate.

In another aspect of the present invention, a plasma display panel includes upper and lower plates, which face each other; and black tops formed on barrier ribs in the lower plate, and comprising a photosensitive substance, which maintains viscosity when it is not exposed to light, and loses the viscosity when it is exposed to the light.

In another aspect of the present invention, a method for manufacturing a plasma display panel includes forming a barrier rib material on a lower plate, on which address electrodes and a dielectric are provided; forming a black top material comprising a photosensitive substance on the barrier rib material; and forming barrier ribs and black tops by exposing the barrier rib material and the black top material to light and developing the barrier rib material and the black top material.

In yet another aspect of the present invention, a method for manufacturing a plasma display panel includes forming a multi-layer green sheet comprising a photosensitive substance on a lower plate, on which address electrodes and a dielectric are provided; and forming barrier ribs and black tops by exposing the multi-layer green sheet to light and developing the multi-layer green sheet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic perspective view of a conventional plasma display panel;

FIGS. 2A to 2D are sectional views illustrating a method for manufacturing a plasma display panel in accordance with a first embodiment of the present invention;

FIG. 3 is a sectional view of a black top green sheet in accordance with the present invention;

FIGS. 4A to 4D are sectional views illustrating a method for manufacturing a plasma display panel in accordance with a second embodiment of the present invention;

FIGS. 5A to 5D are sectional views illustrating a method for manufacturing a plasma display panel in accordance with a third embodiment of the present invention; and

FIGS. 6A to 6C are sectional views illustrating a method for manufacturing a plasma display panel in accordance with a fourth embodiment of the present invention.

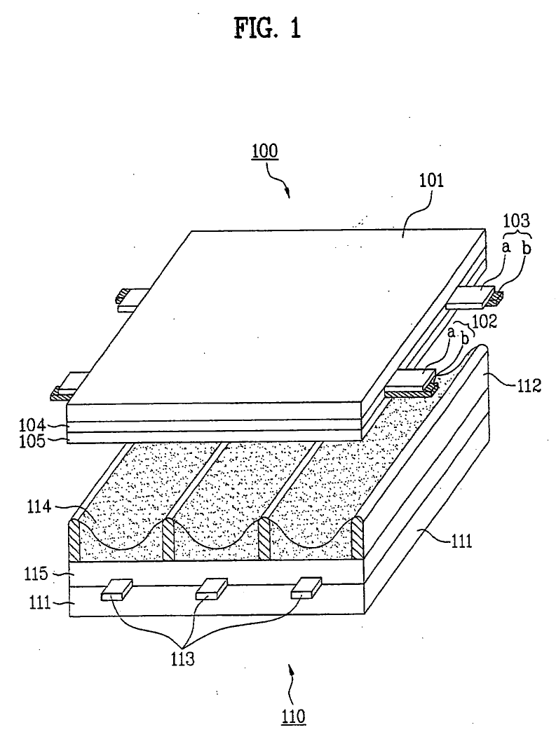

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

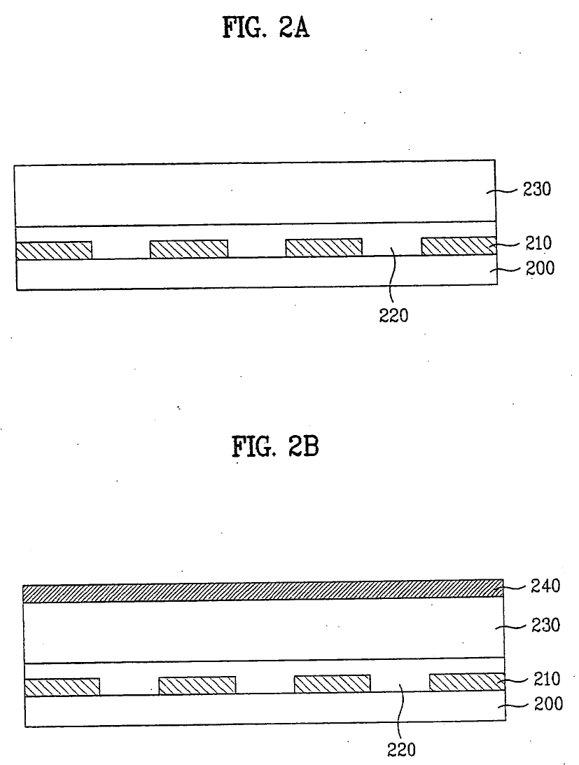

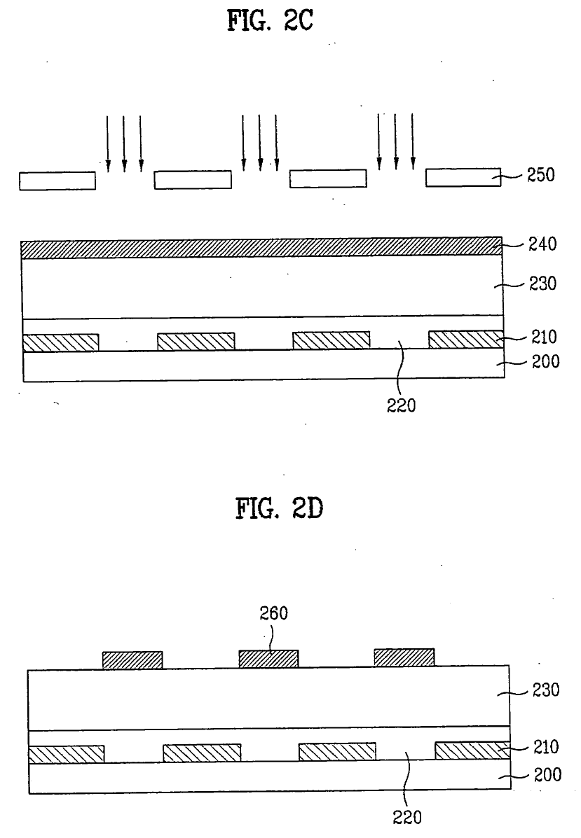

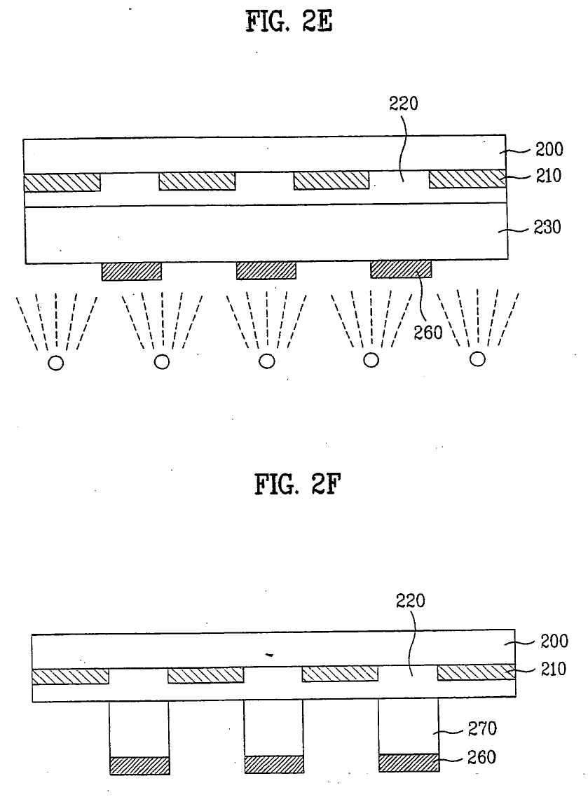

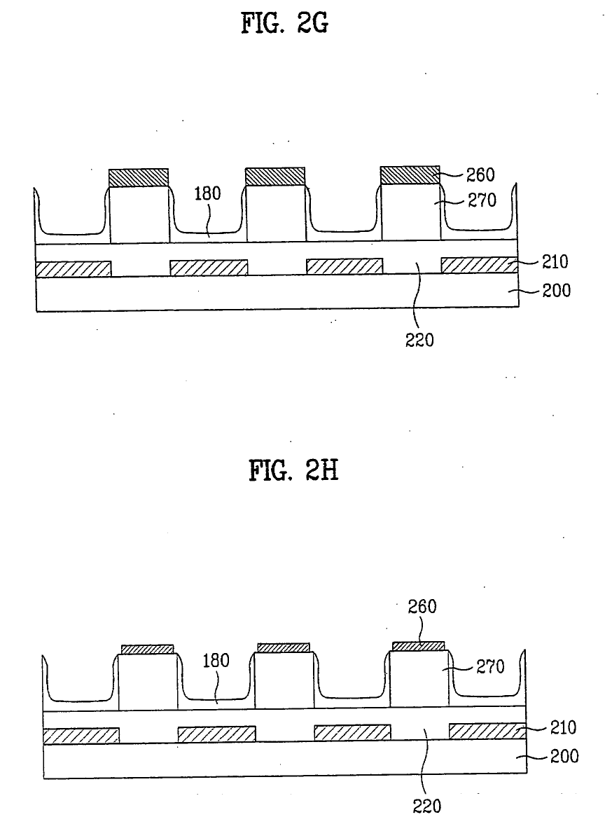

FIGS. 2A to 2H are views illustrating a method for manufacturing a plasma display panel in accordance with a first embodiment of the present invention. Hereinafter, with reference to FIGS. 2A to 2H, the method for manufacturing the plasma display panel in accordance with the first embodiment will be described.

First, as shown in FIG. 2A, a lower dielectric 220 is formed on a lower glass 200, on which address electrodes 210 are provided. Then, a barrier rib material 230 is formed on the lower dielectric 220. In order to improve the luminance of the plasma display panel, the barrier rib material 230 preferably includes a white substance.

Thereafter, as shown in FIG. 2B, a black top material 240 is formed on the barrier rib material 230. The barrier rib material 240 is manufactured in a green sheet type and laminated on the lower glass 200, or is manufactured in a paste type and printed on the lower glass 200. In order to perform an exposing process, which will be described later, the black top material 240 preferably includes a photosensitive substance. More preferably, the photosensitive substance is a photosensitive monomer.

Thereafter, as shown in FIG. 2C, the black top material 240 is patterned. In the patterning of the black top material 240, ultraviolet rays are selectively irradiated onto the black top material 240 using a mask 250. Thereafter, portions of the black top material 240, which are exposed to the ultraviolet rays, are removed by a developing process, thus forming black tops 260, as shown in FIG. 2D.

Thereafter, as shown in FIG. 2E, the barrier rib material 230 is patterned using the black tops 260 as a mask. Preferably, the patterning of the barrier rib material 230 is achieved by an etching or sanding method. The black tops 260 are not damaged during the patterning of the barrier rib material 230 using the etching or sanding method.

FIG. 2F illustrates barrier ribs 270 obtained by patterning the barrier rib material 230.

Thereafter, as shown in FIG. 2G, fluorescent materials 280 are applied to the upper surface of the dielectric 220 and the side surfaces of the barrier ribs 270. Red (R), Green (G), and Blue (B) fluorescent materials 280 are alternately applied, and sub-pixels, on which the R, G, and B fluorescent materials 280 are respectively formed, form one pixel.

As shown in FIG. 2H, the fluorescent materials 280 and the black tops 260 are simultaneously baked. Through the baking process, the width of the black tops 260 is contracted to be narrower than that of the barrier ribs 270, and preferably to be 80˜90% of that of the barrier ribs 270. The contraction of the width of the black tops 260 is caused by the composition of the black top material 240. Preferably, in addition to the photosensitive substance, the black top material 240 further includes a glass composite, a binder, and an initiator. The contraction degree of the black tops 260 during the baking process is varied according to the amount of the binder. In order to allow the width of the black tops 269 to be contracted to be 80˜90% of that of the barrier ribs 270, the amount of the binder in the black top material 260 is preferably 30˜50% of the total amount of the black top material 260.

The plasma display panel manufactured by the above method has the black tops formed on the white barrier ribs, and thus has an improved contrast. As described above, the width of the black tops is adjusted, thereby preventing the deterioration of the luminance of the plasma display panel. The plasma display panel has the black tops including the photosensitive substance formed on the barrier ribs and does not require a DFR layer, thus preventing the addition of steps of the manufacturing process. Further, since the fluorescent materials and the black tops are simultaneously baked, it is possible to simultaneously achieve the removal of organic matters and the adjustment of the width of the black tops.

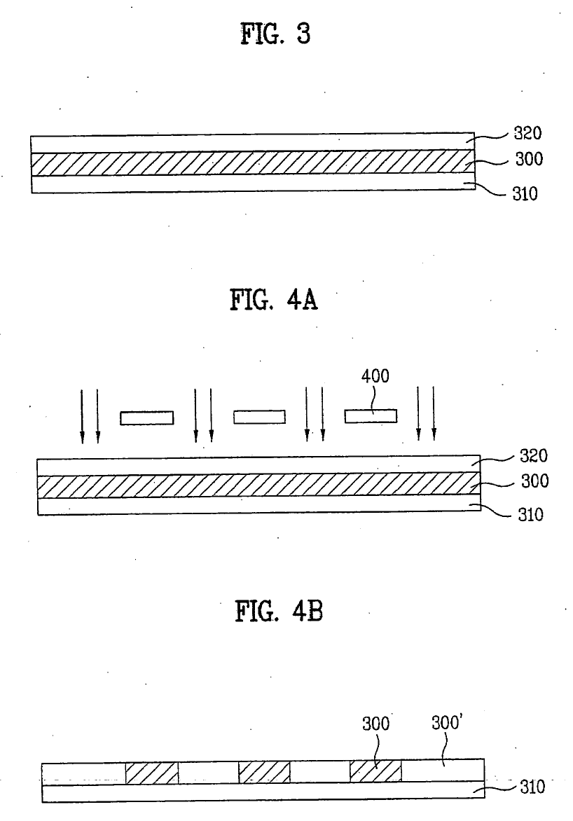

FIG. 3 is a sectional view of a black top green sheet in accordance with the present invention. Hereinafter, with reference to FIG. 3, the black top green sheet of the present invention will be described.

The black top green sheet of the present invention comprises a black paste layer 300, and first and second films 310 and 320 provided at both surfaces of the black paste layer 300. The black paste layer 300 is made of a black-colored material having a light absorbing property, the viscosity of which is changed by ultraviolet rays irradiated thereonto. That is, the black paste layer 300 preferably includes a photosensitive material, which has the viscosity with the first and second films 310 and 320, and is hardened by ultraviolet rays irradiated thereonto and loses the viscosity. More preferably, the black paste layer 300 further includes a black inorganic pigment, an organic binder made of an organic matter, and a solvent.

The above photosensitive material is a photosensitive polymer, which includes a polymer and a photosensitizer. Since the photosensitive material has a negative property, the bonding force of the photosensitive is increased when it is exposed to light.

The first and second films 310 and 320 are formed on the upper and lower surfaces of the black paste layer 300, and serve as protection films. In order to perform an exposing process, which will be described later, preferably, at least one of the first and second films 310 and 320 is transparent. Further, in order to easily attach and remove the first and second films 310 and 320 to and from the black paste layer 300, preferably, the first and second films 310 and 320 have surface characteristics, which reduce the viscosity of the black paste layer 300.

The above black top green sheet serves as not only a material for forming black tops on the surface of barrier ribs, but also a black matrix. Further, the black top green sheet may serve various purposes for forming a black pattern layer. Preferably, the black top green sheet is first patterned and then formed on the surface of structures, such as barrier ribs, rather than is first formed directly on the upper surface of the structures and then patterned. That is, although structures, such as the black tops, to which a black material layer is applied, are complicated and the thickness of the layer is limited so that the layer cannot be formed by a printing method, the black top green sheet is used to easily form the black material layer having a small thickness. Particularly, in case that a layer to be formed has a fine thickness or cannot be patterned by etching, the black top green sheet is useful.

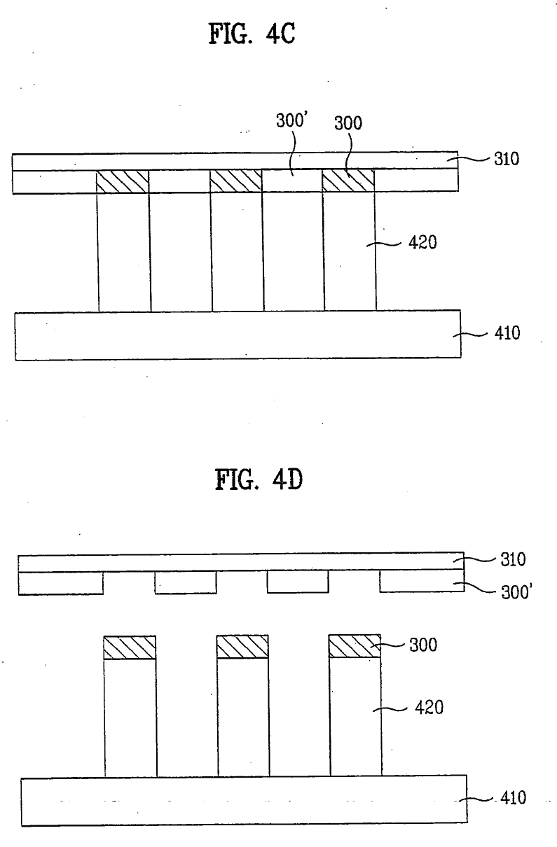

FIGS. 4A to 4D are sectional views illustrating a method for manufacturing a plasma display panel in accordance with a second embodiment of the present invention. Hereinafter, with reference to FIGS. 4A to 4D, the method for manufacturing the plasma display panel in accordance with the second embodiment will be described.

First, the black top green sheet, as shown in FIG. 3, is prepared. Then, as shown in FIG. 4A, the black top green sheet is selectively exposed to light. Specifically, a mask 400 is located on the black top green sheet in such a manner that portions of the black top green sheet corresponding to barrier ribs are not exposed to the light, and then the black top green sheet is selectively exposed to the light. Since the black paste layer 300 includes the organic binder and the solvent so that the viscosity of the black paste layer 300 is maintained, the black paste layer 300 is dried and hardened in a subsequent process, thus being decreased in terms of volume. Accordingly, in consideration of the decrease of the volume of the black paste layer 300, the mask 400 preferably has a pattern, which causes portions of the black green sheet having a width wider than that of the upper surface of the barrier ribs not to be exposed to the light.

Thereafter, as shown in FIG. 4B, the bonding force between molecules of the polymer in the exposed portions 300′ of the black paste layer 300 is increased, and the exposed portions 300′ of the black paste layer 300 lose the viscosity. On the other hand, other portions of the black paste layer 300, i.e., non-exposed portions of the black paste layer 300, maintain the viscosity. After the above change of the viscosity of the black paste layer 300 is completed, one of the first and second protection films 310 and 320 formed on both surfaces of the black paste layer 300 is removed.

Thereafter, as shown in FIG. 4C, a lower plate 410 provided with barrier ribs 420 is prepared, and the black top green sheet, from which the second protection film 320 is removed, is arranged on the lower plate 410. Then, the barrier ribs 420 and the black paste layer 300 are compressed against each other, and preferably compressed against each other using a roller.

Thereafter, as shown in FIG. 4D, the first film 310 and the exposed portions 300 of the black paste layer 300 attached to the first film 00 are separated from the lower plate 410. Here, the non-exposed portions of the black paste layer 300 are firmly compressed against the barrier ribs 420, thus not separated from the lower plate 410.

In the above method of this embodiment, in order to improve the white ray reflecting property of the barrier ribs and the improvement of the contrast due to the black tops formed on the upper surfaces of the barrier ribs, the black tops preferably have a thickness of below 30% of that of the barrier ribs.

Processes for forming other parts except for the process for forming the barrier ribs and the black tops in the method of this embodiment are the same as those in the conventional method. Accordingly, it is possible to easily separate the exposed portions of the black paste layer from the lower plate, while increasing the viscosity of the non-exposed portions of the black paste layer with the barrier ribs. Further, since the black paste layer is selectively exposed to light according to the pattern of the barrier ribs, and is then transcribed onto the barrier ribs, it is possible to adjust the thickness of the black paste layer. Moreover, the barrier ribs are not exposed to an etchant for a long period of time, thus not being distorted.

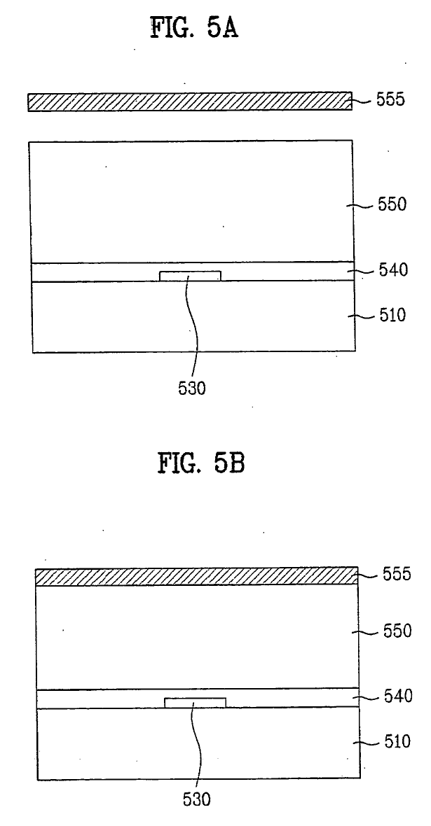

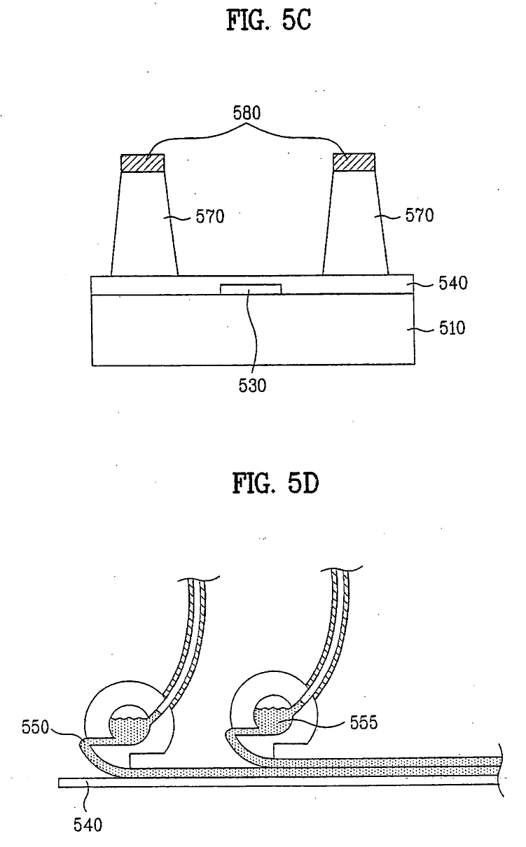

FIGS. 5A to 5D are sectional views illustrating a method for manufacturing a plasma display panel in accordance with a third embodiment of the present invention. Hereinafter, with reference to FIGS. 5A to 5D, the method for manufacturing the plasma display panel in accordance with the third embodiment will be described.

First, as shown in FIG. 5A, a barrier rib material 550 is prepared, and is formed on a lower glass 510, on which address electrodes 530 and a dielectric 540 are sequentially provided. Preferably, the barrier rib material 550 is manufactured in a green sheet type and laminated on the lower glass 510, or is manufactured in a paste type and formed on the lower glass 510 by printing or coating. The barrier rib material 550 is obtained by mixing a mixture, obtained by mixing several tens of % of an oxide in a powdery state, such as Al₂O₃, for improving reflection property and controlling permittivity with PbO or non-PbO glass powder, with an organic solvent.

Thereafter, as shown in FIG. 5B, a black top material 555 is formed on the barrier rib material 550. Preferably, the black top material 555 includes a photosensitive substance. Further, preferably, the black top material 555 is manufactured in a green sheet type and laminated on the barrier rib material 550, or is manufactured in a paste type and formed on the barrier rib material 550 by printing or coating.

Thereafter, as shown in FIG. 5C, the barrier rib material 550 and the black top material 555 are exposed to light, and are developed, thus forming barrier ribs 570 and black tops 580. During the exposing process, a mask is aligned on the upper surface of the black top material 555. The mask has light shielding portions and light transmitting portions, which are alternately formed at the same interval. The light transmitting portions transmit light so that the light is irradiated onto the barrier rib material 550 under the light transmitting portions and hardens the barrier rib material 550, and the light shielding portions shield light so that the light is not irradiated onto the barrier rib material 550 under the light shielding portions.

Thereafter, the barrier ribs 570 and the black tops 580, as shown in FIG. 2C, are formed by developing the barrier rib material 550 and the black top material 555. The above exposure and development is performed by a sanding, etching, or photosensitive method, thus removing the barrier rib material 550 and the black top material 555 under the light shielding portions. Preferably, the barrier rib material 550 and the black top material 555 are simultaneously formed using two coating heads, as shown in FIG. 5D.

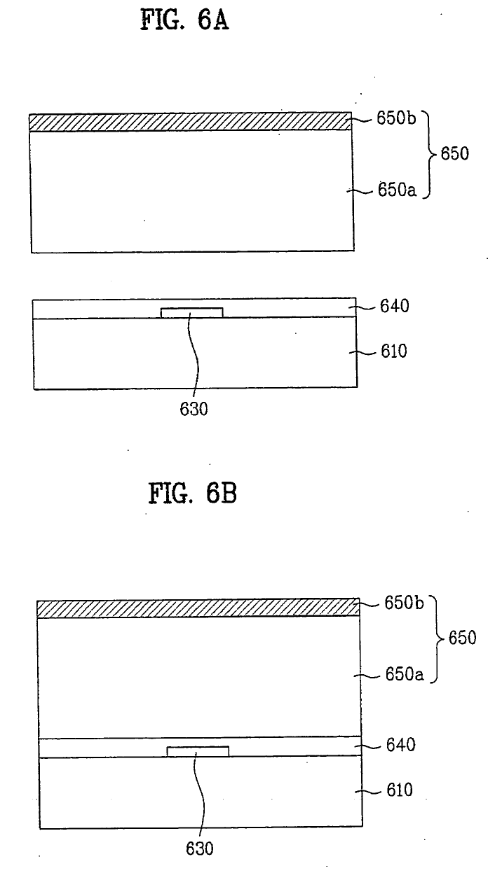

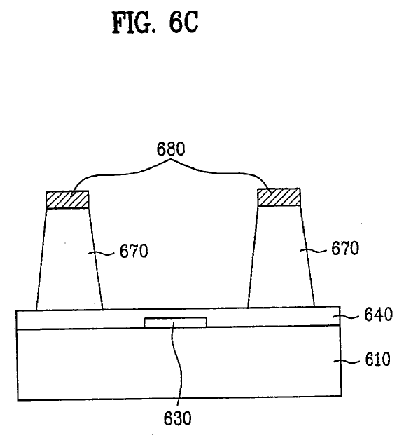

FIGS. 6A to 6C are sectional views illustrating a method for manufacturing a plasma display panel in accordance with a fourth embodiment of the present invention. Hereinafter, with reference to FIGS. 6A to 6C, the method for manufacturing the plasma display panel in accordance with the fourth embodiment will be described.

First, as shown in FIG. 6A, a multi-layer green sheet 650 is prepared. Preferably, the multi-layer green sheet 650 includes a barrier rib material layer 650a, and a black top material layer 650b including a photosensitive substance. That is, in the fourth embodiment, the barrier rib material and the black top material of the third embodiment are combined into a single green sheet, and the green sheet is formed on a lower plate of the plasma display panel. Accordingly, preferably, the multi-layer green sheet 650 of the fourth embodiment includes components of the barrier rib material and the black top material of the third embodiment.

Thereafter, as shown in FIG. 6B, the multi-layer green sheet 650 is formed on a lower glass 610, on which address electrodes 630 and a dielectric 640 are sequentially provided. Preferably, the multi-layer green sheet 650 is laminated on the lower glass 610.

Thereafter, the multi-layer green sheet 650 is exposed to light, and is developed, thus forming barrier ribs and black tops. Preferably, the multi-layer green sheet 650 is selectively exposed to the light using a mask in the same manner as the method of the third embodiment.

Thereafter, as shown in FIG. 6C, barrier ribs 670 and black tops 680 are formed by developing the multi-layer green sheet 550. Preferably, the above exposure and development is performed by a sanding, etching, or photosensitive method.

In accordance with the third and fourth embodiments, the black tops and the barrier ribs are simultaneously formed without the formation of the conventional DFR layer, thus reducing production costs of the plasma display panel and shortening the manufacturing process of the plasma display panel.

The plasma display panel manufactured by the above method uses barrier ribs and a black top material including a photosensitive substance, thus simplifying a process for manufacturing the plasma display panel and reducing the production costs of the plasma display panel. Although the barrier ribs are made of a white material, the black tops, which are formed on the barrier ribs, reduce the reflectance of external light, thus maximizing the contrast of the plasma display panel.

Further, the above method may be applied to other display panels, such as an OLED and an LCD, as well as a plasma display panel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for manufacturing a plasma display panel comprising:
forming a barrier rib material on a lower plate, on which address electrodes and a dielectric are provided;
forming a black top material comprising a photosensitive substance on the barrier rib material;
patterning the black top material to form black tops; and
patterning the barrier rib material using the black tops as a mask to form barrier ribs.

2. The method according to claim 1, wherein the black top material is formed by a green sheet method or a printing method.

3. The method according to claim 1, wherein the patterning of the black top material comprises exposing the black top material using a mask and developing the black top material.

4. The method according to claim 1, wherein the patterning of the barrier rib material using the black tops as the mask is achieved by one of an etching method and a sanding method.

5. The method according to claim 1, wherein the black tops have a narrower width than that of the barrier ribs.

6. The method according to claim 5, wherein the black tops have a width of 80˜90% of that of the barrier ribs.

7. The method according to claim 1, wherein the photosensitive substance is a photosensitive monomer.

8. The method according to claim 1, wherein the black top material further comprises a glass composite, a binder, and an initiator.

9. The method according to claim 8, wherein the weight of the binder is 30˜50% of the total weight of the black top material.

10. The method according to claim 1, further comprising applying fluorescent materials on the upper surface of the dielectric and the side surfaces of the barrier ribs, and simultaneously baking the fluorescent materials and the black tops.

11. A plasma display panel comprising:
upper and lower plates, which face each other;
barrier ribs formed on the lower plate and comprising a white material; and
black tops formed on the barrier ribs and having a narrower width than that of the barrier ribs.

12. The plasma display panel according to claim 11, wherein the black tops are patterned through a photosensitive process.

13. A black top green sheet comprising:
a photosensitive black paste layer, which has viscosity when it is not exposed to light, and loses the viscosity when it is exposed to the light; and
first and second protection films provided on the upper and lower surfaces of the black paste layer.

14. The black top green sheet according to claim 13, wherein the black paste -layer comprises a photosensitive substance, which is hardened when it is exposed to the light, a black inorganic pigment, and an organic binder.

15. The black top green sheet according to claim 13, wherein at least one of the first and second protection films has a surface characteristic in that one surface thereof contacting the black paste layer reduces the viscosity of the black paste layer.

16. A method for manufacturing a plasma display panel comprising:
preparing a black top green sheet, the viscosity of which is changed when it is exposed to light;
selectively exposing the black top green sheet to light according to regions corresponding to barrier ribs; and
bonding non-exposed portions of the black top green sheet to the barrier ribs provided on a lower plate.

17. The method according to claim 16, wherein the black top green sheet comprises:
a photosensitive black paste layer, which has viscosity when it is not exposed to light, and loses the viscosity when it is exposed to the light; and
first and second protection films provided on the upper and lower surfaces of the black paste layer.

18. The method according to claim 17, wherein the black paste layer comprises a photosensitive substance, which is hardened when it is exposed to the light, a black inorganic pigment, and an organic binder.

19. The method according to claim 17, wherein the bonding of the non-exposed portions of the black top green sheet to the barrier ribs comprises:
aligning the black top green sheet, from which the second protection film is removed, on the lower plate so that non-exposed portions of the black top green sheet coincide with the barrier ribs, and compressing the non-exposed portions of the black top green sheet against the barrier ribs; and
removing exposed portions of the black top green sheet and the first film from the lower plate.

20. The method according to claim 19, wherein the compression of the non-exposed portions of the black top green sheet to the barrier ribs is achieved by rolling the black top green sheet on the barrier ribs using a roller.

21. The method according to claim 16, wherein the black top green sheet has a thickness of below 30% of that of the barrier ribs.

22. A plasma display panel comprising:
upper and lower plates, which face each other; and
black tops formed on barrier ribs in the lower plate, and comprising a photosensitive substance, which maintains viscosity when it is not exposed to light, and is hardened and loses the viscosity when it is exposed to the light.

23. The plasma display panel according to claim 22, wherein the black tops have a thickness of below 30% of that of the barrier ribs.

24. A method for manufacturing a plasma display panel comprising:
forming a barrier rib material on a lower plate, on which address electrodes and a dielectric are provided;
forming a black top material comprising a photosensitive substance on the barrier rib material; and
forming barrier ribs and black tops by exposing the barrier rib material and the black top material to light and developing the barrier rib material and the black top material.

25. The method according to claim 24, wherein the barrier rib material and the black top material are simultaneously formed using two coating heads.

26. A method for manufacturing a plasma display panel comprising:
forming a multi-layer green sheet comprising a photosensitive substance on a lower plate, on which address electrodes and a dielectric are provided; and
forming barrier ribs and black tops by exposing the multi-layer green sheet to light and developing the multi-layer green sheet.

27. The method according to claim 26, wherein the multi-layer green sheet includes a barrier rib material layer, and a black top material layer comprising the photosensitive substance.
